(19) United States
(12) Patent Application Publication
(10) Pub. No.: US 2025/0002741 A1
(43) Pub. Date: Jan. 2, 2025

(54) CONDUCTIVE COMPOSITION AND METHOD OF PRODUCING SAME, METHOD OF RECORDING CONDUCTIVE IMAGE, AND CONDUCTIVE IMAGE

(71) Applicants: CANON KABUSHIKI KAISHA, Tokyo (JP); CANON VIRGINIA, INC., Newport News, VA (US)

(72) Inventors: MASANORI SEKI, Kanagawa (JP); TAIKI WATANABE, Tokyo (JP); YUMA KOBAYASHI, Kanagawa (JP); MAYA YASHIMA, Kanagawa (JP); TAIHEI MUKAIDE, Kanagawa (JP)

(21) Appl. No.: 18/830,372

(22) Filed: Sep. 10, 2024

Related U.S. Application Data
(63) Continuation of application No. PCT/JP2023/008706, filed on Mar. 8, 2023.

(30) Foreign Application Priority Data
Mar. 10, 2022 (JP) 2022-037459
Feb. 20, 2023 (JP) 2023-023924

(51) Int. Cl. C09D 11/52; C09D 11/30; H01B 1/22

(52) U.S. Cl. CPC C09D 11/52; C09D 11/30; H01B 1/22

(57) ABSTRACT

Provided are a conductive composition, which is excellent in dispersion stability of a metal particle, and with which a conductive image excellent in conductivity can be easily recorded by only performing simple posttreatment, and a method of producing the conductive composition. The conductive composition contains a metal particle and a polypeptide, and at least a part of a surface of the metal particle is coated with the polypeptide. The polypeptide includes at least one kind of amino acid unit selected from the group consisting of: an acidic amino acid; and a neutral amino acid, and a ratio (% by mass) of the amino acid unit constituting the polypeptide is 95% by mass or more.

### CROSS-REFERENCE TO RELATED APPLICATIONS

This application is a Continuation of International Patent Application No. PCT/JP2023/008706, filed Mar. 8, 2023, which claims the benefit of Japanese Patent Application No. 2022-037459, filed Mar. 10, 2022, and Japanese Patent Application No. 2023-023924, filed Feb. 20, 2023, all of which are hereby incorporated by reference herein in their entirety.

### BACKGROUND

### Field of the Disclosure

The present disclosure relates to a conductive composition and a method of producing the conductive composition, a method of recording a conductive image, and a conductive image.

### Description of the Related Art

As a material for recording and forming a film-shaped conductive image, such as a pattern or a circuit that shows conductivity, a liquid conductive composition including a metal particle is used. In order to stably disperse the metal particle in such conductive composition and maintain dispersion stability thereof, a treatment agent that may adsorb to the metal particle needs to be used. However, such treatment agent is a component that does not contribute to the conductivity, and hence has needed to be removed from a recorded conductive image by being subjected to firing treatment at high temperature or washing treatment using a solvent. However, along with the diversification of a base material on which the conductive image is recorded, a conductive composition for which the firing treatment at high temperature is not needed is required.

For example, there is a proposal of a dispersant for an inorganic nanoparticle using a peptide having four amino acids as a treatment agent (Japanese Patent Application Laid-Open No. 2016-093796). In addition, there is a proposal of a conductive ink, which contains a copper nanoparticle coated with gelatin or a collagen peptide, and which can be ejected from a liquid ejection head of an ink jet system (Japanese Patent Application Laid-Open No. 2016-186033).

However, a component that does not contribute to the conductivity cannot be sufficiently removed by only performing simple posttreatment such as drying without performing firing at high temperature after the conductive ink or the like proposed in each of Japanese Patent Application Laid-Open No. 2016-093796 and Japanese Patent Application Laid-Open No. 2016-186033 is applied to a base material, and hence it has been difficult to record an image excellent in conductivity. Further, those conductive inks and the like are also insufficient in dispersion stability.

### SUMMARY

Accordingly, an object of the present disclosure is to provide a conductive composition, which is excellent in dispersion stability of a metal particle, and with which a conductive image excellent in conductivity can be easily recorded by only performing simple posttreatment. In addition, another object of the present disclosure is to provide a method of producing the conductive composition, a recording method for a conductive image using the conductive composition and a conductive image.

That is, according to the present disclosure, there is provided a conductive composition including: a metal particle; and a polypeptide, wherein the polypeptide includes at least one kind of amino acid unit selected from the group consisting of: an acidic amino acid; and a neutral amino acid, and a ratio (% by mass) of the amino acid unit constituting the polypeptide is 95% by mass or more, and wherein at least a part of a surface of the metal particle is coated with the polypeptide.

Further features of the present disclosure will become apparent from the following description of exemplary embodiments.

### DETAILED DESCRIPTION

The present disclosure is described in more detail below by way of exemplary embodiments. In the present disclosure, when a compound is a salt, the salt is present as dissociated ions in a composition, but the expression “contain a salt” is used for convenience. In the present disclosure, a conductive composition is sometimes simply referred to as “composition” or “ink”. In addition, the “image” in the present disclosure encompasses, for example, a letter, a photograph, a line drawing, a wiring and a pattern and the “recording” or “forming” refers to expressing a desired “image” on a base material. Physical property values are values at normal temperature (25° C.), unless otherwise stated.

The inventors of the present disclosure have made various investigations, and as a result, have found that it is effective that at least a part of the surface of the metal particle be coated with a specific polypeptide. The polypeptide includes at least one kind of amino acid unit selected from the group consisting of: an acidic amino acid; and a neutral amino acid, and a ratio (% by mass) of the amino acid unit constituting the polypeptide is 95% by mass or more. That is, the inventors have found that it is effective to use, as a treatment agent for a metal particle, a specific polypeptide including: a nitrogen atom that functions as an adsorption and/or chemical bond site to the metal particle; and a hydrophilic group that functions to disperse the metal particle in a liquid medium. That is, the metal particle and the specific polypeptide including a hydrophilic group (carboxylic acid group or amino group) are used in combination. The inventors have found that, with the above-mentioned configuration, a conductive composition, which is excellent in dispersion stability, and with which a conductive image excellent in conductivity can be recorded by only performing simple posttreatment such as drying, is obtained. Thus, the inventors have reached the present disclosure.

### <Conductive Composition>

The conductive composition of the present disclosure contains a metal particle and a polypeptide. The polypeptide includes at least one kind of amino acid unit selected from the group consisting of: an acidic amino acid; and a neutral amino acid, and a ratio (% by mass) of the amino acid unit constituting the polypeptide is 95% by mass or more. In addition, at least a part of the surface of the metal particle is coated with the polypeptide. It is preferable that the conductive composition be a liquid at 25° C. Each of components for forming the conductive composition is described below.

### (Metal Particle)

The conductive composition contains the metal particle. The metal particle is preferably formed of at least one kind of metal selected from the group consisting of: nickel; palladium; platinum; copper; silver; and gold. The metal for forming the metal particle is preferably platinum, copper, silver or gold, more preferably silver or gold, particularly preferably gold out of those metals. The content (% by mass) of the metal particle in the conductive composition is preferably 1.0% by mass or more to 50.0% by mass or less with respect to the total mass of the composition.

The metal particle is present in the conductive composition in a dispersed state. The volume-based 50% cumulative particle diameter of the metal particle in the conductive composition is preferably 1 nm or more to 100 nm or less, more preferably 5 nm or more to 50 nm or less from the viewpoint of dispersion stability of the metal particle. The “volume-based 50% cumulative particle diameter” is hereinafter also simply referred to as “average particle diameter.” When the average particle diameter of the metal particle is less than 5 nm, the number of metal particles per unit mass is increased in the conductive composition. As a result, a plurality of metal particles are liable to collide with each other to aggregate, and the dispersion stability of the metal particle may be liable to be decreased. Meanwhile, when the average particle diameter of the metal particle is more than 100 nm, the metal particle is liable to precipitate in the conductive composition, and the dispersion stability of the metal particle may be liable to be decreased. The volume-based 50% cumulative particle diameter (average particle diameter) of the metal particle may be measured by a dynamic light scattering method. When the metal particle is formed of gold or silver, a particle diameter of the metal particle can be simply judged by measuring an ultraviolet-visible absorption spectrum.

The shape of the metal particle is preferably a substantially spherical shape. In the present disclosure, when the ratio of a short diameter “b” of the metal particle to a long diameter “a” thereof is 0.9 or more, the shape of the metal particle is described to be a substantially spherical shape. The ratio of the short diameter “b” of the metal particle to the long diameter “a” thereof is used as an indicator indicating that the metal particle has a substantially spherical shape. In order to determine the ratio of the short diameter “b” of the metal particle to the long diameter “a” thereof, the long diameter “a” and short diameter “b” of the metal particle are first measured. Specifically, after the conductive composition (dispersion liquid or ink) is appropriately diluted with water, the metal particle is photographed with a transmission electron microscope (TEM) or a scanning electron microscope (SEM). Then, the longest diameter passing through the particle center of gravity of the smallest unit for forming the metal particle is defined as a long diameter “a”, and the shortest diameter passing therethrough is defined as a short diameter “b”. The ratio of the short diameter “b” to the long diameter “a” is calculated from the long diameter “a” and the short diameter “b” measured in this manner. Then, an average value of the ratios of the short diameters “b” of 30 metal particles to the long diameters “a” thereof is defined as the ratio of the short diameter “b” of the metal particle to the long diameter “a” thereof. The ratio of the short diameter “b” of the metal particle to the long diameter “a” thereof is preferably 0.9 or more. In addition, the ratio of the short diameter “b” to the long diameter “a” is theoretically 1.0 or less.

### (Polypeptide)

The conductive composition contains a polypeptide, which includes at least one kind of amino acid unit selected from the group consisting of: an acidic amino acid; and a neutral amino acid and in which the ratio (% by mass) of the amino acid unit is 95% by mass or more. The above-mentioned polypeptide is hereinafter also simply referred to as “polypeptide”. The upper limit of the above-mentioned ratio is 100% by mass. The polypeptide is preferably water-soluble. As used herein, the fact that the compound is “water-soluble” means that the compound is present in a liquid composition at 25° C. in a state of not forming a particle having a particle diameter that can be measured.

There are 20 kinds of amino acids each serving as a structural unit of a polypeptide. The amino acids are classified into three kinds: an acidic amino acid; a basic amino acid; and a neutral amino acid. There are two kinds of acidic amino acids: aspartic acid (D); and glutamic acid (E). There are three kinds of basic amino acids: arginine (R); histidine (H); and lysine (K). The neutral amino acids are alanine (A), asparagine (N), glycine (G), cysteine (C), glutamine (Q), isoleucine (I), leucine (L), methionine (M), phenylalanine (F), proline (P), serine(S), threonine (T), tryptophan (W), tyrosine (Y) and valine (V).

Examples of such a polypeptide that the ratio of at least one kind of amino acid unit selected from the group consisting of: an acidic amino acid; and a neutral amino acid constituting the polypeptide is 95% by mass or more may include fibroin, polyglutamic acid and polyaspartic acid. Fibroin includes amino acid units, such as alanine, glycine, serine and tyrosine, and the ratio of an acidic amino acid and a neutral amino acid is about 98% by mass. Polyglutamic acid includes a glutamic acid unit, and the ratio of an acidic amino acid and a neutral amino acid is 100% by mass. In addition, polyaspartic acid includes an aspartic acid unit, and the ratio of an acidic amino acid and a neutral amino acid is 100% by mass. A polypeptide may be synthesized by a peptide solid-phase synthesis method using an amino acid in which an amino group is protected by a protective group, such as a Fmoc group (9-fluorenylmethyloxycarbonyl group) or a Boc group (tert-butoxycarbonyl group).

A polypeptide, such as gelatin or a collagen peptide in which the ratio (% by mass) of at least one kind of amino acid unit selected from the group consisting of: an acidic amino acid; and a neutral amino acid is small includes a basic amino acid unit in a large amount. When a polypeptide in which the above-mentioned ratio is less than 95% by mass is used, the reduction of the metal particle by an amino group of the basic amino acid takes precedence over the reaction between the peptide moiety and the metal particle. As a result, the dispersion stability of a conductive composition to be obtained becomes insufficient. An example of a polypeptide in which the ratio (% by mass) of at least one kind of amino acid unit selected from the group consisting of: an acidic amino acid; and a neutral amino acid is small may be gelatin (91% by mass).

The hydrophilic group (carboxylic acid group or amino group) in the polypeptide may form a salt. As a cation for forming a salt with a carboxylic acid group, there may be given, for example, an alkali metal ion, an ammonium ion and an organic ammonium ion. Examples of the alkali metal ion may include lithium, sodium and potassium ions. Examples of the organic ammonium ion may include alkylamine and alkanolamine ions. As an anion for forming a salt with an amino group, there may be given, for example, a hydroxide ion and a halide ion. Examples of the halide ion may include iodine, bromine and chlorine ions.

When the conductive composition further contains an aqueous medium, the kind of an amino acid to which the hydrophilic group is to be applied may be selected in accordance with the pH of the aqueous medium. For example, when the liquid property of the aqueous medium is acidic (pH<7), a tertiary alkylamino group and a heteroaromatic group each easily form a salt. Meanwhile, when the liquid property of the aqueous medium is alkaline (pH>7), a hydroxy group and a carboxylic acid group each easily form a salt.

The polypeptide includes a peptide bond portion and a hydrophilic group (carboxylic acid group and amino group). The peptide bond portion is a portion that interacts with the metal particle. The hydrophilic group functions as a dispersion group for dispersing the metal particle. When such polypeptide is used, the metal particle can be stably dispersed in a liquid medium such as an aqueous medium. Further, a conductive composition with which a conductive image excellent in conductivity can be easily formed by only performing simple posttreatment such as drying can be obtained.

At least a part of the surface of the metal particle is coated with the polypeptide. It is conceived that the polypeptide interacts with the metal particle, and hence the polypeptide adheres to the surface of the metal particle to be immobilized thereon.

In order to improve the dispersion stability of the conductive composition, it is important to strengthen the interaction between the metal particle and the polypeptide. The interaction between the metal particle and the polypeptide includes physical adsorption and chemical adsorption. In the case of physical adsorption, it is conceived that the van der Waals interaction and ion adsorption are combined and are in an equilibrium state. Meanwhile, in the case of chemical adsorption, it is conceived that a metal atom contained in the metal particle and a nitrogen atom contained in the polypeptide form a chemical bond (covalent bond). Because of this, the adsorption amount is larger in chemical adsorption than in physical adsorption. Thus, as represented by the following general formulae (1) and (2), it is preferable that a metal atom (M) contained in the metal particle and a nitrogen atom (N) contained in the polypeptide be chemically bonded to each other. In the following general formulae (1) and (2), M represents a metal atom contained in the metal particle.

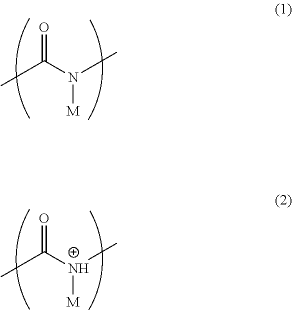

The bond between the metal atom (M) and the nitrogen atom (N) (hereinafter also referred to as “M-N bond”) can be identified by measuring an infrared absorption spectrum. When the M-N bond is formed, an absorption peak of the infrared absorption spectrum derived from M-N stretching vibration appears in a wavelength band of from 450 cm⁻¹ to 600 cm⁻¹. The method of identifying the M-N bond is described, for example, in Tohoku Industrial Research Institute Report, No. 4, October 1974, p. 15-19.

A commercially available product may be used as the polypeptide. When the polypeptide is not commercially available, a synthesized polypeptide may be used. A polypeptide may be synthesized by, for example, a conventionally known peptide solid-phase synthesis method using a Fmoc group or a Boc group as a protective group of an amino group. Fibroin that is an example of a polypeptide may be purified in accordance with a known method described, for example, in Nature Protocols, 2011, Vol. 6, p. 1612-1631.

The content (% by mass) of the polypeptide in the conductive composition is preferably 0.00001% by mass or more to 1.0% by mass or less, more preferably 0.001% by mass or more to 0.1% by mass or less with respect to the total mass of the composition.

It is preferable that the metal atom contained in the metal particle and the nitrogen atom contained in the polypeptide be chemically bonded to each other and that the metal particle be appropriately coated with the polypeptide. Specifically, it is preferable that the surface of the metal particle be uniformly coated with the polypeptide. For this purpose, the content (% by mass) of the polypeptide in the conductive composition is preferably 0.001 times or more to 0.100 times or less, more preferably 0.005 times or more to 0.075 times or less in terms of mass ratio with respect to the content (% by mass) of the metal particle. When the above-mentioned mass ratio is less than 0.005 times, the polypeptide is too small in amount to sufficiently coat the surface of the metal particle, and a region in which the polypeptide does not adhere to the surface of the metal particle is liable to be present. Then, when a plurality of metal particles collide with each other in the conductive composition, the metal particles may coalesce or aggregate to increase the particle diameter of each of the metal particles. As a result, the dispersion stability may not be sufficiently obtained. Meanwhile, when the above-mentioned mass ratio is more than 0.075 times, the volume occupied by the polypeptide in the conductive image recorded with the conductive composition becomes larger. As a result, conductivity may not be sufficiently obtained. In addition, when the conductive composition is ejected from a liquid ejection head of an inkjet system, the ejection property may be slightly decreased.

When the particle diameter of the metal particle is determined, a surface area per metal particle can be calculated. Accordingly, when an occupied area per molecule of the polypeptide can be estimated, the number of molecules for coating the surface of one metal particle can be calculated. The occupied area may be determined as an estimated value by setting the diameter of an atom to 1.5 Å, calculating a sectional area thereof and multiplying the sectional area by the number of the atoms of the polypeptide.

In addition, a saturated adsorption amount for coating the metal particle may be estimated, and the estimated amount may be used as a guideline addition amount. Specifically, the adsorption amount is plotted with respect to the addition amount of the polypeptide. When the obtained plot (adsorption isotherm) is a curve in accordance with a Langmuir-type adsorption isotherm, a region in which, even when the addition amount is increased, the adsorption amount is not increased and is hence the saturation region is present. Accordingly, the adsorption amount in the region can be regarded as the saturated adsorption amount.

Whether or not at least a part of the surface of the metal particle is coated with the polypeptide may be recognized by a zeta potential of the metal particle. A metal particle not coated with the polypeptide typically has a zeta (2) potential of 0 mV or more. That is, the zeta potential shows zero or a plus value having a small absolute value (value of from about 0 mV to about +3 mV). In contrast, the zeta potential of the metal particle in which at least a part of the particle surface is coated with the polypeptide is less than 0. That is, the zeta potential indicates a minus value (specifically, a value of −1 mV or less). This is because the hydrophilic group in the polypeptide undergoes ionic dissociation to become an anion. The zeta potential may be measured with a zeta potential measurement apparatus. In the measurement of the zeta potential, in order to remove the polypeptide that does not coat the metal particle, it is preferable to use a sample prepared by subjecting the conductive composition to centrifugation treatment, removing the supernatant to provide a wet cake and then diluting the wet cake with water.

From the viewpoint of dispersibility, the zeta potential of the metal particle in which at least a part of the particle surface is coated with the polypeptide is preferably −30 mV or less (which is a negative value and is 30 mV or more in terms of an absolute value). When the zeta potential is more than −30 mV (which is a negative value and is less than 30 mV in terms of an absolute value), the coating of the metal particle with the polypeptide is small. As a result, the metal particles are liable to aggregate, and hence the dispersion stability may not be sufficiently obtained. In addition, the chart of the zeta potential has a single peak top. In addition, the shape of the peak is sharp, and the half width of the peak tends to be small.

In addition, whether or not at least a part of the surface of the metal particle is coated with the polypeptide may also be recognized by tracking the amount of each of the polypeptides before and after being brought into contact with the metal particle. Whether or not at least a part of the surface of the metal particle is coated with the polypeptide may be verified by, for example, after bringing the metal particle and the polypeptide into contact with each other, subjecting the resultant to centrifugation to perform solid-liquid separation and then subjecting the polypeptide in the supernatant to be obtained to quantitative analysis. The polypeptide in the supernatant may be subjected to quantitative analysis by, for example, gel permeation chromatography (GPC).

### (Liquid Medium)

The conductive composition may further contain a liquid medium. As the liquid medium, any of a non-aqueous medium and an aqueous medium may be used. An example of the non-aqueous medium may be a liquid medium including an organic solvent, such as heptane or petroleum ether. The non-aqueous medium is free of water. The aqueous medium contains water, and may further contain various organic solvents. The conductive composition preferably further contains the aqueous medium.

The aqueous medium is water or a mixed medium of water as a main component and a protic organic solvent or an aprotic organic solvent used in combination. As the organic solvent, an organic solvent miscible with water at any ratio (water-miscible organic solvent) or an organic solvent soluble in water at any ratio (water-soluble organic solvent) is preferably used. Of those, a uniform mixed medium containing 50% by mass or more of water is preferably used as the aqueous medium. As the water, deionized water (ion-exchanged water) or ultrapure water is preferably used.

The protic organic solvent is an organic solvent having a hydrogen atom (acidic hydrogen atom) bonded to an oxygen atom or a nitrogen atom. The aprotic organic solvent is an organic solvent free of an acidic hydrogen atom. Examples of the organic solvent may include alcohols, (poly)alkylene glycols, glycol ethers, glycol ether esters, carboxylic acid amides, ketones, ketoalcohols, cyclic ethers, nitrogen-containing solvents and sulfur-containing solvents.

Examples of the aqueous medium may include water, a mixed solvent of water and an alcohol, a mixed solvent of water and a (poly)alkylene glycol and a mixed solvent of water and a nitrogen-containing solvent. The content (% by mass) of water in the conductive composition is preferably 10.0% by mass or more to 90.0% by mass or less, more preferably 50.0% by mass or more to 90.0% by mass or less with respect to the total mass of the conductive composition.

The content (% by mass) of the water-soluble organic solvent in the conductive composition is preferably 5.0% by mass or more to 90.0% by mass or less, more preferably 10.0% by mass or more to 50.0% by mass or less with respect to the total mass of the conductive composition.

### (Resin)

The conductive composition may further contain a resin. The resin is different from the polypeptide. When the resin is added to the conductive composition, the physical properties, such as viscosity and surface tension, of the conductive composition can be easily adjusted. In addition, when the resin is added to the conductive composition, the performance of a conductive image to be recorded with the conductive composition, such as hardness, flexibility and adhesiveness to the base material, can also be adjusted. The kind of the resin to be incorporated into the conductive composition is preferably selected so as to correspond to the material for forming the base material to which the conductive composition is applied. For example, when the resin to be added to the conductive composition and the resin material for forming the base material having so-called “SP values” close to each other are selected, it is conceived that the adhesiveness of the conductive image to the base material may be enhanced. Suitable resin combinations are described later.

The content (% by mass) of the resin in the conductive composition is preferably 0.01% by mass or more to 20.0% by mass or less, more preferably 0.05% by mass or more to 20.0% by mass or less with respect to the total mass of the conductive composition. The content is particularly preferably 0.1% by mass or more to 10.0% by mass or less out of those ranges. When the content of the resin in the conductive composition is too small, the degree of adjustment of the physical properties of the conductive composition and the degree of adjustment of the performance of the conductive image obtained by adding the resin may be decreased. Meanwhile, when the content of the resin in the conductive composition is too large, the conductivity of the conductive image may not be sufficiently obtained.

Examples of the resin may include polyester, polyurethane, polyolefin, polystyrene, acrylic, polyvinyl chloride, polyvinyl acetate, polyvinyl pyrrolidone, polyamide, polyimide, epoxy, polyvinyl alcohol and a polysaccharide. Of those, at least one kind of resin selected from the group consisting of: polyester; polyurethane; polyolefin; polyvinyl acetate; and polyamide is more preferable. The resin may be a resin formed of a plurality of kinds of resins described above (e.g., copolymer or composite resin).

The resin may include an ionic group (anionic group or cationic group) or may not include an ionic group. A resin including an anionic group or a resin free of an ionic group is preferable because such resin is less liable to influence the repulsive force of minus charge possessed by the metal particle in which at least a part of the particle surface is coated with the polypeptide, and the resin can stably coexist with the metal particle in the conductive composition. In the case of a conductive composition containing an aqueous liquid medium, a resin including an anionic group or a resin free of an ionic group may be particularly preferably used. In addition, when a resin including a cationic group is used, it is preferable that the content of the resin in the conductive composition be determined in consideration of the repulsive force with respect to the metal particle. The weight-average molecular weight of the resin is preferably 2,000 or more to 100,000 or less. The weight-average molecular weight of the resin is a value in terms of polystyrene measured by gel permeation chromatography (GPC).

The resin may be a soluble resin that can be dissolved in a liquid medium or a resin particle that is dispersed in a liquid medium, but the resin is more preferably a resin particle. As used herein, the expression “resin is soluble” means that, when the resin is neutralized with alkali in an amount equivalent to its acid number, the resin is present in a liquid medium in a state of not forming a particle having a particle diameter that can be measured by a dynamic light scattering method. Whether or not the resin is soluble can be determined in accordance with the method described below. Here, a conductive composition containing an aqueous liquid medium and a resin including an anionic group are described as examples, but the same determination can be made also when the liquid medium is non-aqueous or when the resin includes a cationic group except that the components are replaced by the corresponding components.

First, a liquid (resin solid content: 10% by mass) containing a resin neutralized with alkali (sodium hydroxide, potassium hydroxide or the like) equivalent to its acid number is prepared. Next, the prepared liquid is diluted 10 times (on a volume basis) with pure water to prepare a sample solution. Then, in the case where the particle diameter of the resin in the sample solution is measured by the dynamic light scattering method, when the particle having a particle diameter is not measured, it can be determined that the resin is soluble. The measurement conditions in this case may be set to, for example, SetZero of 30 seconds, the number of times of measurement of 3 times and a measurement time of 180 seconds. In addition, a particle size analyzer (e.g., product name: “UPA-EX150”, manufactured by Nikkiso Co., Ltd.) based on a dynamic light scattering method or the like may be used as a particle size distribution measurement apparatus. Needless to say, the particle size distribution measurement apparatus, measurement conditions and the like to be used are not limited to the foregoing.

### (Other Additive)

The conductive composition may further contain such an organic compound that is solid at normal temperature (25° C.) as described below as required: a polyhydric alcohol, such as trimethylolpropane or trimethylolethane; or urea or a urea derivative such as ethylene urea. In addition, the conductive composition may further contain any one of various additives, such as a surfactant, a pH adjuster, a rust inhibitor, an antiseptic, an antifungal agent, an antioxidant, an anti-reducing agent, an evaporation accelerator and a chelating agent, as required.

As the surfactant, for example, any of anionic, cationic and nonionic surfactants may be used. The content (% by mass) of the surfactant in the conductive composition is preferably 0.1% by mass or more to 5.0% by mass or less, more preferably 0.1% by mass or more to 2.0% by mass or less with respect to the total mass of the conductive composition.

As the surfactant, nonionic surfactants, such as a polyoxyethylene alkyl ether, a polyoxyethylene fatty acid ester, a polyoxyethylene alkyl phenyl ether, a polyoxyethylene-polyoxypropylene block copolymer and an acetylene glycol-based compound, are each preferably used.

### <Method of Producing Conductive Composition>

Next, a method of producing the above-mentioned conductive composition is described. As a method of producing the conductive composition, there may be given two production methods (first production method and second production method) described below. The first production method includes: a first step of reducing a metal salt in an aqueous medium to form a metal particle; and a second step of bringing the formed metal particle and a polypeptide into contact with each other. The second production method includes: a first step of heating a metal salt and a polypeptide to 40° C. or more to 150° C. or less in an aqueous medium to form a precursor in which a metal atom contained in the metal salt and a nitrogen atom contained in the polypeptide are chemically bonded to each other; and a second step of reducing the formed precursor.

### (First Production Method)

### [First Step]

In the first step, the metal salt is reduced in the aqueous medium to form the metal particle. The reaction temperature may be set in accordance with the kind of the metal salt and the liquid medium. For example, the reaction temperature is preferably set to 0° C. or more to 150° C. or less.

### [Second Step]

In the second step, the metal particle formed in the first step and the polypeptide are brought into contact with each other. Specifically, it is only required that the metal particle and the polypeptide be mixed in an aqueous medium. Thus, an intended conductive composition can be obtained. The temperature at which the second step is performed is preferably set to 0° C. or more to 50° C. or less and may be set to the vicinity of room temperature (20° C. or more to 30° C. or less).

### (Second Production Method)

### [First Step]

In the first step, the metal salt and the polypeptide are heated to 40° C. or more to 150° C. or less in the aqueous medium to be caused to react with each other. Specifically, after the polypeptide is added to an aqueous solution of the metal salt, the resultant is heated to a range of from 40° C. or more to 150° C. or less under stirring. The heating temperature may be determined in accordance with a liquid medium. When a liquid medium formed of water alone is used, the heating temperature is set to preferably 40° C. or more, more preferably 50° C. or more, and is also set to preferably 100° C. or less that is the boiling point of water in consideration of a reflux temperature. In addition, when a liquid medium that is a mixed medium of water and an organic solvent (suitably having a boiling point higher than that of water) is used, the heating temperature is set to preferably 40° C. or more to 150° C. or less in consideration of the azeotropy of the water and the organic solvent. Thus, a precursor in which a metal atom contained in the metal salt and a nitrogen atom contained in the polypeptide are chemically bonded to each other can be formed.

Whether or not the precursor has been formed can be recognized based on the presence or absence of the bond between the metal atom (M) and the nitrogen atom (N). The bond between the metal atom (M) and the nitrogen atom (N) (hereinafter also referred to as “M-N bond”) can be identified by measuring an infrared absorption spectrum. When an M-N bond is newly formed, an absorption peak in an infrared absorption spectrum derived from M-N stretching vibration appears in a wavelength band of from 450 cm⁻¹ to 600 cm⁻¹. Whether or not the precursor has been formed can be determined based on the presence or absence of the absorption peak.

### [Second Step]

In the second step, the precursor obtained in the first step is reduced. Thus, there can be obtained an intended conductive composition containing a metal particle in which the metal particle is coated with a polypeptide under a state in which a metal atom contained in the metal particle and a nitrogen atom contained in the polypeptide are chemically bonded to each other. The reaction temperature can be set in accordance with the kind of the metal salt and the liquid medium, and for example, is set to preferably 0° C. or more to 150° C. or less.

### [Components to be Used in Production Methods]

Components to be used in the above-mentioned first production method and second production method are described below.

### (Aqueous Medium)

As an aqueous medium, the above-mentioned aqueous medium that may be incorporated into the conductive composition may be used. That is, only water or a mixed medium of water as a main component and a protic organic solvent or an aprotic organic solvent used in combination may be used. As the organic solvent, an organic solvent miscible with water at any ratio (water-miscible organic solvent) or an organic solvent soluble in water at any ratio (water-soluble organic solvent) is preferably used. Of those, a uniform mixed medium containing 50% by mass or more of water is preferably used as the aqueous medium. As the water, deionized water (ion-exchanged water) or ultrapure water is preferably used.

### (Metal Salt)

Examples of the metal salt may include: a metal salt including a metal ion and an inorganic anion species; a metal salt including a metal ion and an organic anion species; and a metal salt including a metal ion and an inorganic/organic anion species. As the metal ion, ions of metals that may form metal particles, such as nickel, palladium, platinum, copper, silver and gold, may each be used. Examples of the inorganic anion species may include anions of an oxide, a halogen, carbonic acid and nitric acid. Examples of the organic anion species may include anions of carboxylic acids, such as formic acid and acetic acid.

Specific examples of the metal salt may include: nickel compounds, such as nickel (II) chloride and nickel (II) nitride; palladium compounds, such as palladium (II) chloride, palladium (II) acetate and palladium (II) oxide; platinum compounds, such as platinum (II) chloride and platinum (IV) oxide; copper compounds, such as copper (I) chloride, copper (II) chloride, copper (I) oxide and copper (II) oxide; silver compounds, such as silver (I) chloride, silver nitride, silver oxide and silver acetate; and gold compounds, such as gold (III) oxide, gold (I) chloride, tetragold octachloride, gold (III) chloride, gold (III) bromide, gold (III) fluoride, gold (V) fluoride, gold (I) hydroxide and gold (III) hydroxide.

In recent years, the following possibility has been pointed out: resources of a material, such as a noble metal or a rare metal, which is used in an electronic device and the like, may be depleted in several decades when the material is kept being used without any measure. Such material is called a critical material, and in order not to deplete the resource, an effort of recovering those resources from a used noble metal product or a waste electronic device to recycle those resources has been performed in each country. Recycling of a noble metal, such as platinum, gold or silver, out of such resources has been advanced as compared to other resources, and a regeneration technology has started to be established. As a method of regenerating gold, there is given, for example, a method including removing any other metal from a recovered waste product, dissolving and leaching gold with aqua regia or an organic solvent, followed by recrystallization of gold with a reducing agent to increase its purity and further melting the resultant to form a lump having removed organic matter therefrom. When the recovered noble metal is reused as a product, purity guarantee is needed. For example, in the case of gold, a high purity of 99.99% needs to be guaranteed.

From such viewpoint, a recovered metal salt recovered from a metal waste liquid is also preferably used as the metal salt. For example, when a conductive composition containing a gold particle as the metal particle is produced, chloroauric (III) acid utilizing the recovered gold may be used. Chloroauric (III) acid may be prepared by drying a gold-aqua regia solution generated in the middle of the above-mentioned method of regenerating gold.

When the conductive composition containing a gold particle as the metal particle is produced, the regenerated chloroauric (III) acid may be used as one of starting raw materials. Gold has a high reducing property, and hence even when the regenerated chloroauric (III) acid contains another metal impurity, the gold particle is preferentially formed. Accordingly, high purity guarantee is unnecessary for the regenerated chloroauric (III) acid. The purity of chloroauric (III) acid is preferably 90% or more, more preferably 95% or more. In a regeneration process for gold, a step in association with purity guarantee can be omitted to suppress a raw material cost.

In addition, when a conductive composition containing a silver particle as the metal particle is produced, high purity guarantee is unnecessary for silver (I) nitrate that may be used as one of starting raw materials. The purity of silver (I) nitrate is preferably 90% or more, more preferably 95% or more. In a regeneration process for silver, a step in association with purity guarantee can be omitted to suppress a raw material cost.

Silver (I) nitrate may be recovered from a waste in accordance with a known method. For example, when a dichromate salt is added to a filtrate obtained by adding nitric acid to a waste liquid containing silver to acidulate the liquid and separating a precipitate, silver dichromate is generated as a precipitate. Silver (I) nitrate may be recovered by dissolving the precipitate of silver dichromate in hot dilute nitric acid, followed by treatment with a NO₃-type anion-exchange resin.

### (Reducing Agent)

A reducing agent is preferably used for reducing the metal salt. Examples of the reducing agent may include: alcohols each having a primary hydroxy group, such as methanol, ethanol, 1-propanol and ethylene glycol; alcohols each having a secondary hydroxy group, such as 2-propanol and 2-butanol; alcohols each having a primary hydroxy group and a secondary hydroxy group, such as glycerin; thiols; aldehydes, such as formaldehyde and acetaldehyde; sugars, such as glucose, fructose, glyceraldehyde, lactose, arabinose and maltose; organic acids, such as citric acid, tannic acid and ascorbic acid, and salts thereof; borohydrides and salts thereof; and hydrazines, such as hydrazine, an alkylhydrazine and hydrazine sulfate. As an anion for forming a salt of the organic acid or the borohydride, there may be given, for example: ions of alkali metals, such as lithium, sodium and potassium; ions of alkaline earth metals, such as calcium and magnesium; an ammonium ion; and organic ammonium ions.

Of those, organic acids and salts thereof are each preferably used as the reducing agent. The organic acids and salts thereof each reduce a metal salt and adhere to the surface of the metal particle to be formed, to thereby enable a repulsive force to such a degree as not to cause aggregation or coalescence of the metal particles to be generated. As the organic acids and salts thereof, for example, ascorbic acid and salts thereof and citric acid and salts thereof are preferable. Of those, for example, an ascorbic acid salt and a citric acid salt are more preferable.

In addition, a compound, such as polyvinylpyrrolidone, polyvinyl alcohol, polyethylene glycol, gelatin, starch, dextrin, carboxymethyl cellulose, methyl cellulose or ethyl cellulose, may be used as the reducing agent. Those compounds each also reduce a metal salt and adhere to the surface of the metal particle to be formed, to thereby enable an auxiliary repulsive force for preventing aggregation or coalescence of the metal particles from being caused to be generated in the same manner as in the above-mentioned organic acids and salts thereof.

The usage amount of the reducing agent only needs to be appropriately set in accordance with, for example, the kind of the metal, the concentration of the metal salt, the size (particle diameter) of the metal particle to be formed and a temperature and a stirring force when the reducing agent is added. In the first step, the metal salt is preferably reduced while being vigorously stirred. In addition, in the first step, the metal salt is preferably reduced under a heating condition and the metal salt is more preferably reduced while the liquid medium is refluxed. For example, when the reflux is performed through use of a liquid medium formed of water alone, the temperature of a bath (e.g., an oil bath) in which a reaction vessel is placed is set to preferably 115° C. or more to 200° C. or less in order to adjust the heating temperature to 40° C. or more to 100° C. or less.

The metal particle only reduced with the reducing agent and not coated with the treatment agent shows a value of a zeta potential in accordance with the kind of the reducing agent. For example, in Examples to be described below, the gold particle is formed by using citric acid as the reducing agent. The zeta potential of the gold particle having citric acid adhering thereto is about −40 mV. However, the reducing agent such as citric acid has a weak adhesive force to the metal particle, and hence a conductive composition in which a metal particle is continuously stably dispersed is not achieved by only causing the reducing agent such as citric acid to adhere thereto.

### <Method of Recording Conductive Image>

Next, a method of recording a conductive image is described. The method of recording a conductive image of the present disclosure includes a step of applying the above-mentioned conductive composition to a base material. When the conductive composition is applied to the base material, a desired conductive image can be obtained. As a method of applying the conductive composition to the base material, there may be given, for example, an ink jet method, a flexo method and a spin coating method. The conductive composition is preferably applied to the base material by an ink jet method out of those methods. The ink jet method is a method including ejecting the conductive composition from an ejection head of an ink jet system to apply the composition to the base material such as a recording medium. A system of ejecting the conductive composition from the ejection head is, for example, a system involving applying mechanical energy to the conductive composition or a system involving applying thermal energy to the conductive composition. The method of applying the conductive composition to the base material by the ink jet method may be a known method except that the above-mentioned conductive composition is used.

When the conductive image is recorded (formed) by ejecting the conductive composition from the ejection head of the ink jet system to apply the composition to the base material, a conductive composition whose surface tension and viscosity are appropriately controlled is preferably used. In this case, specifically, the content (% by mass) of the metal particle in the conductive composition is preferably 5.0% by mass or more to 30.0% by mass or less with respect to the total mass of the composition. When the content of the metal particle in the conductive composition is less than 5.0% by mass, it may be required to apply the conductive composition a plurality of times in order to record a film-shaped conductive image. Meanwhile, when the content of the metal particle in the conductive composition is more than 30.0% by mass, an ejection orifice may be liable to be clogged due to the high viscosity when the conductive composition is ejected from an ejection head of an ink jet system.

The surface tension of the conductive composition at 25° C. is preferably 10 mN/m or more to 60 mN/m or less, more preferably 20 mN/m or more to 60 mN/m or less, particularly preferably 30 mN/m or more to 50 mN/m or less. The viscosity of the conductive composition at 25° C. is preferably 1.0 mPa's or more to 10 mPa's or less, more preferably 1.0 mPa's or more to 5 mPa's or less. The pH of the conductive composition at 25° C. is preferably 3.0 or more to 9.0 or less, more preferably 5.0 or more to 9.0 or less.

The method of recording a conductive image may further include a step of drying the conductive composition applied to the base material. When the above-mentioned conductive composition is used, the conductive image having excellent conductivity can be recorded by only performing drying at low temperature such as normal temperature (25° C.) even when the composition is not dried at a high temperature of, for example, 100° C. or more. The conductive composition applied to the base material may be dried by, for example, air blowing or heating, but may be dried without utilizing these methods, that is, naturally dried. The conductive composition applied to the base material may be dried at a temperature of preferably 20° C. or more to 120° C. or less, more preferably 20° C. or more to 50° C. or less. When the drying temperature is less than 20° C., the time period required for the drying may become longer. When the drying time is shortened, conductivity of the conductive image to be recorded easily becomes higher. When the base material has a high heat-resistant temperature, the drying temperature may be increased to the heat-resistant temperature. However, when the drying temperature is set to be too high, the base material may be deformed. In the recording method of the present disclosure, after the application of the conductive composition to the base material, a step of heating or sintering the conductive composition or a step of curing the conductive composition by irradiation with, for example, an active energy ray may not be performed.

### <Conductive Image>

The conductive image of the present disclosure is a conductive image including a base material and a conductive layer formed on the base material. The conductive layer contains a metal particle and the above-mentioned polypeptide, and at least a part of the particle surface of the metal particle is coated with the polypeptide. The conductive image of the present disclosure is suitably a conductive image to be recorded on the base material, that is, an image formed with the above-mentioned conductive composition.

### (Base Material)

The base material may be any base material on which the conductive image may be recorded by, for example, drying the applied conductive composition. The conductive composition expresses conductivity even through drying at low temperature, and hence a base material having a low heat-resistant temperature may be used. For example, glass, paper, a resin material, ceramics and silicon are each preferably used as the base material. Examples of the resin material may include a biocompatible material and a synthetic resin. The resin material preferably has a plate shape or a sheet shape.

As the resin material, a biocompatible material may be used. The biocompatible material refers to a material that does not have harmful effects on a living body, and is a material having characteristics of being inert to a chemical reaction and a biological defense reaction, not easily causing decomposition, deterioration and elution in a living body, not easily adsorbing other components, and having both flexibility and strength. As the biocompatible material, biodegradable plastics, such as polyhydroxybutyric acid, poly(α-hydroxy ester), poly(β-hydroxy ester), polycyanoacrylate, polyanhydride, polyketone, poly(orthoester), poly-ε-caprolactone, polyacetal, poly(iminocarbonate) and polyphosphazene, proteins, such as polypeptide, gelatin, collagen and fibroin, and polysaccharides, such as cellulose and chitosan, are each preferable. Of those, a biocompatible material formed of at least one kind selected from the group consisting of: gelatin; collagen; fibroin; cellulose; and chitosan is preferable.

As the resin material, a synthetic resin may be used. As the synthetic resin, a resin, such as polyester, polyurethane, polyolefin, polystyrene, acrylic, polyvinyl chloride, polyvinyl acetate, polyamide, polyimide, polycarbonate, epoxy or an acrylonitrile-butadiene-styrene copolymer (ABS), is preferable. Of those, a synthetic resin material formed of at least one kind selected from the group consisting of: polyester; polyolefin; polyimide; and polycarbonate is preferable. Those synthetic resin materials are each suitable as a resin to be used in a substrate such as a flat panel, and each particularly preferably have a plate shape or a sheet shape.

As described above, the kind of the resin to be incorporated into the conductive composition is preferably selected so as to correspond to the material for forming the base material to which the conductive composition is applied. For example, when the resin to be added to the conductive composition and the resin material for forming the base material having so-called “SP values” close to each other are selected, it is conceived that the adhesiveness of the conductive image to the base material may be enhanced.

Suitable combinations of the resin for forming the base material and the resin to be incorporated into the conductive composition are described below. When a base material formed of a polyester resin is used, resins, such as polyester, polyolefin, acrylic, polyvinyl acetate and polyamide, are each preferable as the resin to be incorporated into the conductive composition. When a base material formed of a polyurethane resin is used, a resin such as polyamide is preferable as the resin to be incorporated into the conductive composition. When a base material formed of a polyolefin resin is used, resins, such as polyurethane, polyolefin, acrylic and polyvinyl acetate, are each preferable as the resin to be incorporated into the conductive composition. When a base material formed of a polyvinyl chloride resin is used, resins, such as polyester, polyolefin, polyvinyl acetate and polyimide, are each preferable as the resin to be incorporated into the conductive composition. When a base material formed of a polyamide resin is used, resins, such as polyurethane, acrylic and polyamide, are each preferable as the resin to be incorporated into the conductive composition. When a base material formed of a polyimide resin is used, a resin such as polyamide is preferable as the resin to be incorporated into the conductive composition. When a base material formed of a polycarbonate resin is used, resins, such as polyurethane, polyolefin, acrylic and polyvinyl acetate, are each preferable as the resin to be incorporated into the conductive composition. When a base material formed of an acrylic resin is used, a resin such as acrylic is preferable as the resin to be incorporated into the conductive composition. When a base material formed of an epoxy resin is used, a resin such as polyamide is preferable as the resin to be incorporated into the conductive composition. In addition to the resin materials, when a base material formed of glass is used, a resin such as polyamide is preferable as the resin to be incorporated into the conductive composition.

### Examples

Next, the present disclosure is described in more detail by way of Examples and Comparative Examples. However, the present disclosure is by no means limited to Examples below without departing from the gist of the present disclosure. In the description of the amounts of components, “part(s)” and “%” are by mass unless otherwise specified.

### <Analysis Method for Conductive Composition>

An infrared absorption spectrum was measured with a Fourier transform infrared spectrometer (product name: “Spectrum One-B”, manufactured by PerkinElmer, Inc.). An average particle diameter (volume-based 50% cumulative particle diameter, D50) of a metal particle in a conductive composition was measured with a small-angle X-ray scattering apparatus (product name: “Nano-Viewer”, manufactured by Rigaku Corporation). Measurement conditions at this time were set to a wavelength (λ) of 0.154 nm and an incident angle of 1.7°. The maximum absorption wavelength of the conductive composition was measured with a UV-visible near-infrared spectrophotometer (product name: “UV-3600”, manufactured by Shimadzu Corporation). A zeta potential of the metal particle in the conductive composition was measured with a zeta potentiometer (product name: “Zetasizer Nano”, manufactured by Malvern). At this time, the produced conductive composition was subjected to centrifugation treatment and the supernatant was removed so that a wet cake was obtained. After that, a sample prepared by diluting the wet cake with ultrapure water so as to have a concentration suitable for the measurement was used as a measurement target. The zeta potentials of a gold particle and a silver particle generated by reducing gold (III) chloride tetrahydrate and silver (I) nitrate (all of which were manufactured by Kishida Chemical Co., Ltd.) with trisodium citrate dihydrate were 1 mV and 0 mV, respectively.

### <Preparation of Recovered Metal Salt>

A conductive composition was produced through use of gold recovered from a substrate as a raw material. A base material with gold plating was cut out, and was crushed into a size of about 5 mm×about 5 mm to provide a crushed piece for ease of chemical treatment. The obtained crushed piece was immersed in 10% dilute nitric acid for 2 hours so that copper and nickel were dissolved, and gold-plated foil was floated from the base material. After that, dilute nitric acid was passed through a filter having arranged thereon filter paper to separate the gold-plated foil. Dilute nitric acid showed a blue-green color in which copper and nickel were dissolved. Dilute nitric acid was added to the gold-plated foil on the filter paper, and copper and nickel remaining on a surface of the gold-plated foil were washed out. The obtained gold-plated foil was transferred to another vessel with the filter paper, and an aqua regia solution obtained by mixing 35% hydrochloric acid and 60% nitric acid at 3:1 (volume ratio) was dropped thereinto little by little to dissolve gold. At the time when gold was dissolved, the filter paper was taken out, and the obtained gold-aqua regia solution was filtered so that a fragment of the base material was removed. The filtrate was distilled under reduced pressure while being warmed with an acid-resistant rotary evaporator so that nitric acid, hydrochloric acid and water were removed in the stated order. Thus, chloroauric (III) acid tetrahydrate was obtained.

### <Preparation of Treatment Agent>

The following compounds were each used as the treatment agent. The ratio of the neutral or acidic amino acid constituting the polypeptide is referred to as “ratio of a specific amino acid.”
“Fibroin”: 5% fibroin aqueous solution, manufactured by Sigma-Aldrich Co. LLC, ratio of a specific amino acid of 98%
“Sodium polyglutamate”, manufactured by PEPTIDE INSTITUTE, INC., ratio of a specific amino acid of 100%
“Sodium polyaspartate”, manufactured by Sigma-Aldrich Co. LLC, ratio of a specific amino acid of 100%
“Gelatin”, manufactured by Nacalai Tesque, Inc., ratio of a specific amino acid of 91%
“Polylysine”, manufactured by PEPTIDE INSTITUTE, INC., ratio of a specific amino acid of 0%.
“Fmoc-KVCC”: polypeptide (lysine-valine-cysteine-cysteine) protected with 9-fluorenyloxycarbonyl, which was synthesized by a Fmoc solid-phase synthesis method, ratio of a specific amino acid of 75%

### <Production of Conductive Composition (Dispersion Liquid) by First Production Method>

A conductive composition (dispersion liquid) was produced by a method described below. A metal particle in a conductive composition (dispersion liquid) produced in each of Examples D1 to D18 had a “substantially spherical” shape. The mass ratio of a polypeptide with respect to the metal particle is hereinafter also referred to as “polypeptide/metal particle.”

### Examples D1 to D3 and D7 to D18, and Comparative Example D1

Chloroauric (III) acid tetrahydrate (manufactured by Kishida Chemical Co., Ltd.) in a usage amount shown in Table 1 (Table 1-1 to Table 1-2) and ultrapure water in a usage amount (denoted as a liquid medium) shown in Table 1 were heated and refluxed, and trisodium citrate dihydrate in a usage amount shown in Table 1 was added thereto. As chloroauric (III) acid tetrahydrate in each of Examples D7 to D9, chloroauric (III) acid tetrahydrate obtained in the above-mentioned “Preparation of Recovered Metal Salt” was used. The internal temperature (reaction temperature) was kept at 100° C., followed by stirring for 2 hours. After the resultant was cooled to 25° C., a treatment agent of a kind in a usage amount shown in Table 1 was added thereto, followed by stirring for 15 hours. Thus, conductive compositions D1 to D3 and D7 to D19 were obtained.

### Example D4

106.7 Milligrams of silver (I) nitrate (manufactured by Kishida Chemical Co., Ltd.) and 403.2 mg of trisodium citrate dihydrate were dissolved in 1,000 mL of ultrapure water, and the mixture was stirred for 30 minutes while being cooled with ice. Thus, an aqueous solution was obtained. A solution obtained by dissolving 33 mg of sodium borohydride in 1 g of ion-exchanged water was added to the obtained aqueous solution, followed by further cooling with ice and stirring for 30 minutes. Thus, a brown transparent dispersion liquid was obtained. The temperature of the resultant dispersion liquid was returned to 25° C., and 0.1 g of a 5% fibroin aqueous solution was added thereto while the dispersion liquid was stirred. Further, the resultant was stirred at 25° C. for 30 minutes to provide a conductive composition D4.

### Examples D5 and D6

Conductive compositions D5 and D6 were obtained in the same manner as in the case of Example D4 described above except that 5 mg of sodium polyglutamate or 5 mg of sodium polyaspartate was used instead of 0.10 g of the 5% fibroin aqueous solution, respectively.

TABLE 1-1
Composition of conductive composition (dispersion liquid)

| | | | | | | Treatment agent | |
|---|---|---|---|---|---|---|---|
| | | Conductive | Amount | | Trisodium | | Ratio of |
| | | composition | of liquid | Chloroauric(III) | citrate | | specific |
| | | (dispersion | medium | acid tetrahydrate | dihydrate | | amino |
| | | liquid) | (mL) | (g) | (g) | Kind | acid (%) |
| Example | D1 | D1 | 1,300 | 1 | 1.75 | Fibroin | 98 |
| | D2 | D2 | 1,300 | 1 | 1.75 | Sodium | 100 |
| | | | | | | polyglutamate | |
| | D3 | D3 | 1,300 | 1 | 1.75 | Sodium | 100 |
| | | | | | | polyaspartate | |
| | D4 | D4 | — | — | — | Fibroin | 98 |
| | D5 | D5 | — | — | — | Sodium | 100 |
| | | | | | | polyglutamate | |
| | D6 | D6 | — | — | — | Sodium | 100 |
| | | | | | | polyaspartate | |
| | D7 | D7 | 1,300 | 1 | 1.75 | Fibroin | 98 |
| | D8 | D8 | 1,300 | 1 | 1.75 | Sodium | 100 |
| | | | | | | polyglutamate | |
| | D9 | D9 | 1,300 | 1 | 1.75 | Sodium | 100 |
| | | | | | | polyaspartate | |
| | D10 | D10 | 1,300 | 1 | 1.75 | Fibroin | 98 |
| | D11 | D11 | 1,300 | 1 | 1.75 | Fibroin | 98 |
| | D12 | D12 | 1,300 | 1 | 1.75 | Fibroin | 98 |
| | D13 | D13 | 1,300 | 1 | 1.75 | Fibroin | 98 |
| | D14 | D14 | 13,000 | 1 | 1.75 | Fibroin | 98 |
| | D15 | D15 | 6,500 | 1 | 1.75 | Fibroin | 98 |
| | D16 | D16 | 1,300 | 1 | 1.16 | Fibroin | 98 |
| | D17 | D17 | 1,300 | 1 | 0.58 | Fibroin | 98 |
| | D18 | D18 | 1,300 | 1 | 0.38 | Fibroin | 98 |
| Comparative | D1 | D19 | 1,300 | 1 | 1.75 | Gelatin | 91 |
| Example | | | | | | | |

TABLE 1-2
Composition and characteristics of conductive composition (dispersion liquid)

| | | | | | Characteristics | |
|---|---|---|---|---|---|---|
| | | | | Mass ratio of | | Zeta |
| | | Treatment | Metal | “polypeptide/metal | D50 | potential |
| | | agent (g) | particle | particle” (times) | (nm) | (mV) |
| Example | D1 | 0.40 | Au | 0.042 | 20 | −36 |
| | D2 | 0.02 | Au | 0.042 | 21 | −36 |
| | D3 | 0.02 | Au | 0.042 | 21 | −38 |
| | D4 | — | Ag | 0.074 | 22 | −34 |
| | D5 | — | Ag | 0.074 | 20 | −33 |
| | D6 | — | Ag | 0.074 | 20 | −34 |
| | D7 | 0.40 | Au | 0.042 | 21 | −35 |
| | | | (recovered) | | | |
| | D8 | 0.02 | Au | 0.042 | 20 | −34 |
| | | | (recovered) | | | |
| | D9 | 0.02 | Au | 0.042 | 19 | −36 |
| | | | (recovered) | | | |
| | D10 | 0.03 | Au | 0.003 | 20 | −36 |
| | D11 | 0.05 | Au | 0.005 | 20 | −36 |
| | D12 | 0.72 | Au | 0.075 | 20 | −36 |
| | D13 | 0.76 | Au | 0.079 | 20 | −36 |
| | D14 | 0.40 | Au | 0.042 | 1 | −31 |
| | D15 | 0.40 | Au | 0.042 | 5 | −33 |
| | D16 | 0.47 | Au | 0.042 | 41 | −33 |
| | D17 | 0.40 | Au | 0.042 | 98 | −31 |
| | D18 | 0.01 | Au | 0.001 | 120 | −30 |
| Comparative | D1 | 0.40 | Au | 0.042 | 22 | −18 |
| Example | | | | | | |

### <Production of Conductive Composition (Dispersion Liquid) by Second Production Method>

A conductive composition (dispersion liquid) was produced by a method described below. A metal particle in a conductive composition (dispersion liquid) produced in each of Examples D19 to D32 had a “substantially spherical” shape.

### Examples D19 to D21 and D23 to D32, and Comparative Examples D2 to D4

Chloroauric (III) acid tetrahydrate in a usage amount shown in Table 2 (Table 2-1 to Table 2-2) was dissolved in ultrapure water in a usage amount (denoted as a liquid medium) shown in Table 2, and a treatment agent of a kind in a usage amount shown in Table 2 was added thereto while the solution was stirred. The resultant was stirred at a reaction temperature of 60° C. for 2 hours to provide a reaction liquid containing a precursor. As chloroauric (III) acid tetrahydrate in Example D23, chloroauric (III) acid tetrahydrate obtained in the above-mentioned “Preparation of Recovered Metal Salt” was used. The resultant reaction liquid was heated and refluxed at 60° C., and trisodium citrate dihydrate in a usage amount shown in Table 2 was added thereto. The internal temperature (reaction temperature) was kept at 100° C., followed by stirring for 2 hours. The resultant was cooled to 25° C., followed by stirring for 15 hours. Thus, conductive compositions D20 to D22 and D24 to D36 were obtained. In each of Comparative Examples D2 to D4, the metal particles aggregated. As a result, an average particle diameter of the metal particles was not able to be measured.

The precursor obtained in Example D19 was analyzed with a Fourier transform infrared spectrometer (product name: “Spectrum One-B”, manufactured by PerkinElmer, Inc.). As a result, the chemical bond between the gold atom and the nitrogen atom in the polypeptide was recognized based on the appearance of a strong peak derived from M-N (Au (gold atom)-N) at about 590 cm⁻¹.

### Example D22

108 Milligrams of silver (I) nitrate was dissolved in 1,000 mL of ultrapure water, and 0.10 g of a 5% fibroin aqueous solution was added thereto while the solution was stirred. The resultant was stirred at a reaction temperature of 60° C. for 2 hours to provide a reaction liquid containing a precursor. The obtained precursor was analyzed with a Fourier transform infrared spectrometer (product name: “Spectrum One-B”, manufactured by PerkinElmer, Inc.). As a result, the chemical bond between the silver atom and the nitrogen atom in the polypeptide was recognized based on the appearance of a strong peak derived from M-N (Ag (silver atom)-N) at about 590 cm⁻¹. A solution obtained by dissolving 35 mg of sodium borohydride in 1 g of ion-exchanged water was added to the resultant reaction liquid. The mixture was stirred for another 30 minutes under ice-cold conditions to provide a brown transparent reaction liquid. The reaction liquid was stirred at 25° C. for another 30 minutes to provide a conductive composition D23.

TABLE 2-1
Composition of conductive composition (dispersion liquid)

| | | | | | | Treatment agent | |
|---|---|---|---|---|---|---|---|
| | | Conductive | Amount of | | | | Ratio of |
| | | composition | liquid | Chloroauric(III) | Trisodium | | specific |
| | | (dispersion | medium | acid | citrate | | amino |
| | | liquid) | (mL) | tetrahydrate (g) | dihydrate (g) | Kind | acid (%) |
| Example | D19 | D20 | 1,300 | 1 | 1.75 | Fibroin | 98 |
| | D20 | D21 | 1,300 | 1 | 1.75 | Sodium | 100 |
| | | | | | | polyglutamate | |
| | D21 | D22 | 1,300 | 1 | 1.75 | Sodium | 100 |
| | | | | | | polyaspartate | |
| | D22 | D23 | — | — | — | Fibroin | 98 |
| | D23 | D24 | 1,300 | 1 | 1.75 | Fibroin | 98 |
| | D24 | D25 | 1,300 | 1 | 1.75 | Fibroin | 98 |
| | D25 | D26 | 1,300 | 1 | 1.75 | Fibroin | 98 |
| | D26 | D27 | 1,300 | 1 | 1.75 | Fibroin | 98 |
| | D27 | D28 | 1,300 | 1 | 1.75 | Fibroin | 98 |
| | D28 | D29 | 13,000 | 1 | 1.75 | Fibroin | 98 |
| | D29 | D30 | 6,500 | 1 | 1.75 | Fibroin | 98 |
| | D30 | D31 | 1,300 | 1 | 1.16 | Fibroin | 98 |
| | D31 | D32 | 1,300 | 1 | 0.58 | Fibroin | 98 |
| | D32 | D33 | 1,300 | 1 | 0.38 | Fibroin | 98 |
| Comparative | D2 | D34 | 1,300 | 1 | 1.75 | Gelatin | 91 |
| Example | D3 | D35 | 1,300 | 1 | 1.75 | Polylysine | 0 |
| | D4 | D36 | 1,300 | 1 | 1.75 | Fmoc- | 75 |
| | | | | | | KVCC | |

TABLE 2-2
Composition and characteristics of conductive composition (dispersion liquid)

| | | | | | Characteristics | |
|---|---|---|---|---|---|---|
| | | | | Mass ratio of | | Zeta |
| | | Treatment | Metal | “polypeptide/metal | D50 | potential |
| | | agent (g) | particle | particle” (times) | (nm) | (mV) |
| Example | D19 | 0.20 | Au | 0.021 | 19 | −40 |
| | D20 | 0.01 | Au | 0.021 | 19 | −39 |
| | D21 | 0.01 | Au | 0.021 | 21 | −39 |
| | D22 | — | Ag | 0.073 | 21 | −38 |
| | D23 | 0.20 | Au | 0.021 | 20 | −39 |
| | | | (recovered) | | | |
| | D24 | 0.03 | Au | 0.003 | 19 | −40 |
| | D25 | 0.05 | Au | 0.005 | 19 | −40 |
| | D26 | 0.72 | Au | 0.075 | 19 | −40 |
| | D27 | 0.76 | Au | 0.079 | 19 | −40 |
| | D28 | 0.20 | Au | 0.021 | 1 | −32 |
| | D29 | 0.20 | Au | 0.021 | 5 | −33 |
| | D30 | 0.20 | Au | 0.021 | 40 | −35 |
| | D31 | 0.20 | Au | 0.021 | 100 | −32 |
| | D32 | 0.20 | Au | 0.021 | 120 | −32 |

| | | | | | |
|---|---|---|---|---|---|
| Comparative | D2 | 0.20 | Au | 0.021 | Aggregation |
| Example | D3 | 0.20 | Au | 0.021 | Aggregation |
| | D4 | 0.20 | Au | 0.021 | Aggregation |

### <Production of Conductive Composition (Ink)>

An aqueous ink (conductive composition) including an aqueous medium and a surfactant was produced by the following method. The average particle diameter of the metal particle in each of the obtained inks fell within the range of +1 nm of the average particle diameter of the metal particle in the conductive composition (dispersion liquid) used as a raw material. From this fact, it was found that the metal particle was stably dispersed in each of the conductive composition and the ink.

The conductive composition (dispersion liquid) obtained above was concentrated with an ultrafiltration apparatus (product name: “TFF Minimate Ultrafiltration System”, filter: 30K, manufactured by Pall Corporation) to provide a concentrated liquid of the conductive composition containing a metal particle at a content of 14.85%. Then, each component was mixed so as to achieve the following blending ratio. Thus, each ink containing a metal particle at a content of 10.0% was obtained. An acetylene glycol-based surfactant (product name: “OLFINE PD-005”, manufactured by Nissin Chemical Co., Ltd.) was used as a surfactant.
Concentrated liquid of conductive composition: 67.4 parts
Ethylene glycol: 31.0 parts
Surfactant: 0.1 part
Resin of a kind shown in Table 3 (Table 3-1 to Table 3-2): usage amount (parts) for forming a resin (solid content) of 1.25 parts
Ultrapure water: usage amount (parts) for forming a total of components of 100.0%

The following commercially available products were used as resins shown in Table 3.
Resin 1: water dispersion liquid of polyester resin, (product name: “Vylonal MD-2000”, resin particle content: 40%, manufactured by TOYOBO Co., Ltd.)
Resin 2: water-soluble nylon resin (polyamide resin) (product name: “AQ Nylon A-90”, manufactured by Toray Industries, Inc.)
Resin 3: water dispersion liquid of polyvinyl chloride/polyvinyl acetate copolymer resin (product name: “VINYBLAN 603”, resin particle content: 50%, manufactured by Nissin Chemical Industry Co., Ltd.)
Resin 4: water dispersion liquid of polyamide resin (product name: “SEPOLSION NE205”, resin particle content: 40%, manufactured by Sumitomo Seika Chemicals Co., Ltd.)
Resin 5: water dispersion liquid of polyolefin resin (product name: “SUMIFITT WR101”, resin particle content: 31%, manufactured by Sumitomo Chemical Co., Ltd.)
Resin 6: water dispersion liquid of polyolefin/polyvinyl acetate copolymer resin (product name: “SEPOLSION VA406”, resin particle content: 50%, manufactured by Sumitomo Seika Chemicals Co., Ltd.)
Resin 7: water dispersion liquid of polyurethane resin (product name: “SUPERFLEX 210”, resin particle content: 35%, manufactured by DKS Co. Ltd.)

### <Evaluation of Dispersion Stability>

1 Milliliter of the resultant ink (conductive composition) was placed in a sealable glass bottle and stored in an incubator (product name: “IC602”, manufactured by Yamato Scientific Co., Ltd.) at 60° C. for a predetermined period of time. The ink (conductive composition) after storage was diluted 1,500 times (on a volume basis) with ultrapure water and analyzed with a UV-visible near-infrared spectrophotometer (product name: “UV-3600”, manufactured by Shimadzu Corporation). When the absorption of light at a wavelength of 700 nm was increased by 30% as compared to the absorption before storage, it was determined that the ink “aggregated”, and dispersion stability was evaluated in accordance with the following evaluation criteria based on the storage period of time up to aggregation. The results are shown in Table 3. In the evaluation criteria described below, “A” and “B” were each defined as an acceptable level, and “C” was defined as an unacceptable level.
A: The period of time up to aggregation was 2 weeks or more.
B: The period of time up to aggregation was 1 week or more to less than 2 weeks.
C: The period of time up to aggregation was less than 1 week.

TABLE 3-1
Composition and characteristics of conductive composition (ink)

| | | Conductive | | |
|---|---|---|---|---|
| | | composition | Kind of | Dispersion |
| | | (dispersion liquid) | resin | stability |
| Example | I1 | D1 | 1 | A |
| | I2 | D2 | 1 | A |
| | I3 | D3 | 1 | A |
| | I4 | D4 | 1 | A |
| | I5 | D5 | 1 | A |
| | I6 | D6 | 1 | A |
| | I7 | D7 | 1 | A |
| | I8 | D8 | 1 | A |
| | I9 | D9 | 1 | A |
| | I10 | D10 | 1 | B |
| | I11 | D11 | 1 | A |
| | I12 | D12 | 1 | A |
| | I13 | D13 | 1 | A |
| | I14 | D14 | 1 | B |
| | I15 | D15 | 1 | A |
| | I16 | D16 | 1 | A |
| | I17 | D17 | 1 | B |
| | I18 | D18 | 1 | B |
| | I19 | D1 | 2 | A |
| | I20 | D1 | 3 | A |
| | I21 | D1 | 4 | A |
| | I22 | D1 | 5 | A |
| | I23 | D1 | 6 | A |
| | I24 | D1 | 7 | A |

TABLE 3-2
Composition and characteristics of conductive composition (ink)

| | | Conductive | | |
|---|---|---|---|---|
| | | composition | Kind of | Dispersion |
| | | (dispersion liquid) | resin | stability |
| Example | I25 | D1 | — | A |
| | I26 | D20 | 1 | A |
| | I27 | D21 | 1 | A |
| | I28 | D22 | 1 | A |
| | I29 | D23 | 1 | A |
| | I30 | D24 | 1 | A |
| | I31 | D25 | 1 | B |
| | I32 | D26 | 1 | A |
| | I33 | D27 | 1 | A |
| | I34 | D28 | 1 | A |
| | I35 | D29 | 1 | B |
| | I36 | D30 | 1 | A |
| | I37 | D31 | 1 | A |
| | I38 | D32 | 1 | B |
| | I39 | D33 | 1 | B |
| | I40 | D20 | 2 | A |
| | I41 | D20 | 3 | A |
| | I42 | D20 | 4 | A |
| | I43 | D20 | 5 | A |
| | I44 | D20 | 6 | A |
| | I45 | D20 | 7 | A |
| | I46 | D20 | — | A |
| Comparative | I1 | D19 | 1 | B |
| Example | | | | |

### <Production of Conductive Image>

The ink (conductive composition) was loaded into an ink cartridge and set in an ink jet recording apparatus (product name: “LaboJet-500”, manufactured by MICROJET Corporation) that ejected an ink from a recording head by the action of physical energy with a piezoelectric element. Through use of this ink jet recording apparatus, a solid image was recorded on the following sheet-shaped base material under an environment of a temperature of 25° C. and a relative humidity of 50% while the amount of an ink (conductive composition) applied to a unit region measuring 1/600 inch by 1/600 inch was set to 20 ng. Thus, a recorded product was obtained. The resultant recorded product was dried for a period of time shown in Table 4 (Table 4-1 to Table 4-4) under an environment of a drying temperature shown in Table 4 and a relative humidity of 50%, to thereby provide each conductive image (rectangular image measuring 2 mm by 3 cm).

Details of the base material are shown below.
PET film: product name: “PANACREA ACX”, manufactured by Panac Co., Ltd.
PI: polyimide film, product name: “Kapton H”, manufactured by Du Pont-Toray Co., Ltd.
PP: polypropylene film, product name: “TORAYFAN #40-2500”, manufactured by Toray Industries, Inc.
PC: polycarbonate film, product name: “PURE-ACE D”, manufactured by Teijin Limited
Gelatin sheet: a product obtained by applying a 0.1% gelatin solution manufactured by FUJIFILM Wako Pure Chemical Corporation to the PET film with a bar coater and drying the solution
Fibroin sheet: a product obtained by applying a 5% fibroin aqueous solution manufactured by Millipore Sigma to the PET film with a bar coater and drying the solution

### <Evaluation of Conductivity>

The thickness of the obtained conductive image was measured with a stylus thickness meter (manufactured by Tencor). The sectional area of the conductive image was calculated from the measured thickness and the volume resistivity thereof was measured and calculated by a four-point probe method. In addition, the conductivity of the conductive image was evaluated in accordance with the following evaluation criteria. In the following evaluation criteria, “A” was defined as an acceptable level and “C” was defined as an unacceptable level. The results are shown in Table 4.
A: The volume resistivity was 1×10⁻⁴ Ω·cm or less.
C: The volume resistivity was more than 1×10⁻⁴ Ω·cm or no conductivity was shown.

### <Evaluation of Adhesiveness>

A conductive image (3.5 cm (width)×3.5 cm (length)×1 μm (thickness)) was obtained under the same conditions as those used for the above-mentioned evaluation of conductivity. In the conductive image, vertical and horizontal cuts were formed with a box cutter along a cross-cut plate (product name: “Cross-cut Plate,” cut width; 2 mm, manufactured by Allgood) to produce a lattice-shaped cross-cut. An adhesive tape (Cellotape (trademark) CT-24, manufactured by NICHIBAN Co., Ltd., pressure-sensitive adhesive strength: 4.01 N/10 mm) was applied to the cross-cut portion and then instantly peeled off at an angle of 60°. The peeling state in a coating film (conductive image) was visually observed and classified into the following classifications 0 to 5 with reference to JIS-K5600, “Adhesion cross-cut method”, and the adhesiveness of the conductive image was evaluated in accordance with the following evaluation criteria. In the evaluation criteria described below, “A” and “B” are each defined as an acceptable level, and “A” indicates more satisfactory adhesiveness. The results are shown in Table 4.

### (Classification)

Classification 0: The edge of each cut was smooth, and there was no peeling at any of lattice joints.
Classification 1: There was small peeling of the coating film at the intersections of the cuts, but less than 5% of the cross-cut portions were affected.
Classification 2: The coating film was peeled along the lines of the cuts and/or at the intersections. More than 5% to 15% or less of the cross-cut portions were affected.
Classification 3: The coating film was largely peeled partially or totally along the lines of the cuts and/or a joint portion was partially or totally peeled. More than 15% to 35% or less of the cross-cut portions were affected.
Classification 4: The coating film was largely peeled partially or totally along the lines of the cuts and/or several joint portions were partially or totally peeled. More than 35% to 65% or less of the cross-cut portions were affected.
Classification 5: The degree of peeling was any one of those unable to be classified even in Classification 4.

### (Evaluation Criteria)

A: The results corresponded to Classification 0, Classification 1 or Classification 2.
B: The results corresponded to Classification 3, Classification 4 or Classification 5.

TABLE 4-1
Characteristics of conductive image

| | | Production conditions | | | |
|---|---|---|---|---|---|
| | | Conductive | | Drying | Drying |
| | | composition | Base | temperature | time |
| | | (ink) | material | (° C.) | (h) |
| Example | E1 | I1 | PET | 25 | 24 |
| | E2 | I2 | PET | 25 | 24 |
| | E3 | I3 | PET | 25 | 24 |
| | E4 | I4 | PET | 25 | 24 |
| | E5 | I5 | PET | 25 | 24 |
| | E6 | I6 | PET | 25 | 24 |
| | E7 | I7 | PET | 25 | 24 |
| | E8 | I8 | PET | 25 | 24 |
| | E9 | I9 | PET | 25 | 24 |
| | E10 | I10 | PET | 25 | 24 |
| | E11 | I11 | PET | 25 | 24 |
| | E12 | I12 | PET | 25 | 24 |
| | E13 | I13 | PET | 25 | 24 |
| | E14 | I14 | PET | 25 | 24 |
| | E15 | I15 | PET | 25 | 24 |
| | E16 | I16 | PET | 25 | 24 |
| | E17 | I17 | PET | 25 | 24 |
| | E18 | I18 | PET | 25 | 24 |
| | E19 | I19 | PET | 25 | 24 |
| | E20 | I20 | PET | 25 | 24 |
| | E21 | I21 | PI | 25 | 24 |
| | E22 | I22 | PP | 25 | 24 |
| | E23 | I23 | PC | 25 | 24 |
| | E24 | I24 | PET | 25 | 24 |
| | E25 | I25 | PET | 25 | 24 |
| | E26 | I1 | PET | 15 | 24 |
| | E27 | I1 | PET | 15 | 72 |
| | E28 | I1 | PET | 20 | 24 |
| | E29 | I1 | PET | 50 | 24 |
| | E30 | I1 | PET | 120 | 24 |

TABLE 4-2
Characteristics and evaluation of conductive image

| | | Conductivity | | | |
|---|---|---|---|---|---|
| | | Volume | | | |
| | | resistivity | | Adhesiveness | |
| | | (×10⁻⁵ | Evaluation | JIS K 5600 | Evaluation |
| | | Ω · cm) | results | Classification | results |
| Example | E1 | 3 | A | 0 | A |
| | E2 | 4 | A | 0 | A |
| | E3 | 4 | A | 0 | A |
| | E4 | 4 | A | 0 | A |
| | E5 | 4 | A | 0 | A |
| | E6 | 4 | A | 0 | A |
| | E7 | 4 | A | 0 | A |
| | E8 | 4 | A | 0 | A |
| | E9 | 4 | A | 0 | A |
| | E10 | 3 | A | 0 | A |
| | E11 | 3 | A | 0 | A |
| | E12 | 3 | A | 0 | A |
| | E13 | 3 | A | 0 | A |
| | E14 | 8 | A | 0 | A |
| | E15 | 7 | A | 0 | A |
| | E16 | 5 | A | 0 | A |
| | E17 | 7 | A | 0 | A |
| | E18 | 9 | A | 0 | A |
| | E19 | 7 | A | 0 | A |
| | E20 | 6 | A | 0 | A |
| | E21 | 6 | A | 1 | A |
| | E22 | 8 | A | 2 | A |
| | E23 | 7 | A | 0 | B |
| | E24 | 7 | A | 0 | A |
| | E25 | 6 | A | 5 | A |
| | E26 | 4 | A | 0 | A |
| | E27 | 4 | A | 0 | A |
| | E28 | 4 | A | 0 | A |
| | E29 | 4 | A | 0 | A |
| | E30 | 3 | A | 0 | A |

TABLE 4-3
Characteristics of conductive image

| | | Production conditions | | | |
|---|---|---|---|---|---|
| | | Conductive | | Drying | Drying |
| | | composition | Base | temperature | time |
| | | (ink) | material | (° C.) | (h) |
| Example | E31 | I1 | Gelatin | 25 | 24 |
| | | | sheet | | |
| | E32 | I1 | Fibroin | 25 | 24 |
| | | | sheet | | |
| | E33 | I26 | PET | 25 | 24 |
| | E34 | I27 | PET | 25 | 24 |
| | E35 | I28 | PET | 25 | 24 |
| | E36 | I29 | PET | 25 | 24 |
| | E37 | I30 | PET | 25 | 24 |
| | E38 | I31 | PET | 25 | 24 |
| | E39 | I32 | PET | 25 | 24 |
| | E40 | I33 | PET | 25 | 24 |
| | E41 | I34 | PET | 25 | 24 |
| | E42 | I35 | PET | 25 | 24 |
| | E43 | I36 | PET | 25 | 24 |
| | E44 | I37 | PET | 25 | 24 |
| | E45 | I38 | PET | 25 | 24 |
| | E46 | I39 | PET | 25 | 24 |
| | E47 | I40 | PET | 25 | 24 |
| | E48 | I41 | PET | 25 | 24 |
| | E49 | I42 | PI | 25 | 24 |
| | E50 | I43 | PP | 25 | 24 |
| | E51 | I44 | PC | 25 | 24 |
| | E52 | I45 | PET | 25 | 24 |
| | E53 | I46 | PET | 25 | 24 |
| | E54 | I26 | PET | 15 | 24 |
| | E55 | I26 | PET | 15 | 72 |
| | E56 | I26 | PET | 20 | 24 |
| | E57 | I26 | PET | 50 | 24 |
| | E58 | I26 | PET | 120 | 24 |
| | E59 | I26 | Gelatin | 25 | 24 |
| | | | sheet | | |
| | E60 | I26 | Fibroin | 25 | 24 |
| | | | sheet | | |
| Comparative | E1 | I1 | PET | 25 | 24 |
| Example | | | | | |

TABLE 4-4
Characteristics and evaluation of conductive image

| | | Conductivity | | | |
|---|---|---|---|---|---|
| | | Volume | | | |
| | | resistivity | | Adhesiveness | |
| | | (×10⁻⁵ | Evaluation | JIS K 5600 | Evaluation |
| | | Ω · cm) | results | Classification | results |
| Example | E31 | 4 | A | 0 | A |
| | E32 | 4 | A | 0 | A |
| | E33 | 2 | A | 0 | A |
| | E34 | 4 | A | 0 | A |
| | E35 | 3 | A | 0 | A |
| | E36 | 4 | A | 0 | A |
| | E37 | 4 | A | 0 | A |
| | E38 | 2 | A | 0 | A |
| | E39 | 2 | A | 0 | A |
| | E40 | 2 | A | 0 | A |
| | E41 | 2 | A | 0 | A |
| | E42 | 7 | A | 0 | A |
| | E43 | 6 | A | 0 | A |
| | E44 | 4 | A | 0 | A |
| | E45 | 9 | A | 0 | A |
| | E46 | 9 | A | 0 | A |
| | E47 | 6 | A | 0 | A |
| | E48 | 5 | A | 0 | A |
| | E49 | 5 | A | 1 | A |
| | E50 | 7 | A | 2 | B |
| | E51 | 6 | A | 0 | A |
| | E52 | 6 | A | 0 | A |
| | E53 | 5 | A | 5 | B |
| | E54 | 4 | A | 0 | A |
| | E55 | 4 | A | 0 | A |
| | E56 | 3 | A | 0 | A |
| | E57 | 3 | A | 0 | A |
| | E58 | 3 | A | 0 | A |
| | E59 | 3 | A | 0 | A |
| | E60 | 3 | A | 0 | A |
| Comparative | E1 | 40 | C | 5 | B |
| Example | | | | | |

In the conductive image of each of Examples E30 and E58 in which the drying temperature was set to 120° C., the base material was deformed and warped with heat.

According to the present disclosure, the conductive composition, which is excellent in dispersion stability of the metal particle, and with which a conductive image excellent in conductivity can be easily recorded by only performing simple posttreatment, can be provided. In addition, according to the present disclosure, the method of producing the conductive composition, the recording method for a conductive image using the conductive composition and the conductive image can be provided.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

The present disclosure is not limited to the embodiments described above, and various changes and modifications can be made without departing from the spirit and scope of the present disclosure. The following claims are thus appended hereto in order to make the scope of the present disclosure public.

What is claimed is:

1. A conductive composition comprising:
a metal particle; and
a polypeptide,
wherein the polypeptide comprises at least one kind of amino acid unit selected from the group consisting of: an acidic amino acid; and a neutral amino acid, and a ratio (% by mass) of the amino acid unit constituting the polypeptide is 95% by mass or more, and
wherein at least a part of a surface of the metal particle is coated with the polypeptide.

2. The conductive composition according to claim 1, wherein the polypeptide is at least one of fibroin and polyglutamic acid.

3. The conductive composition according to claim 1, wherein a metal atom in the metal particle and a nitrogen atom in the polypeptide are chemically bonded to each other.

4. The conductive composition according to claim 1, wherein a content (% by mass) of the polypeptide is 0.001 times or more to 0.100 times or less in terms of mass ratio with respect to a content (% by mass) of the metal particle.

5. The conductive composition according to claim 1, wherein a content (% by mass) of the polypeptide is 0.005 times or more to 0.075 times or less in terms of mass ratio with respect to a content (% by mass) of the metal particle.

6. The conductive composition according to claim 1, wherein the metal particle is formed of at least one kind of metal selected from the group consisting of: nickel; palladium; platinum; copper; silver; and gold.

7. The conductive composition according to claim 1, wherein a volume-based 50% cumulative particle diameter of the metal particle is 1 nm or more to 100 nm or less.

8. The conductive composition according to claim 1, wherein a volume-based 50% cumulative particle diameter of the metal particle is 5 nm or more to 50 nm or less.

9. The conductive composition according to claim 1, further comprising an aqueous medium.

10. The conductive composition according to claim 9, further comprising a resin.

11. The conductive composition according to claim 10, wherein the resin comprises at least one kind of resin selected from the group consisting of: polyester; polyurethane; polyolefin; polystyrene; acrylic; polyvinyl chloride; polyvinyl acetate; polyvinyl pyrrolidone; polyamide; polyimide; epoxy; polyvinyl alcohol; and a polysaccharide.

12. The conductive composition according to claim 10, wherein the resin comprises at least one kind of resin selected from the group consisting of: polyester; polyurethane; polyolefin; polyvinyl acetate; and polyamide.

13. A method of producing the conductive composition of claim 1, the method comprising:
a first step of reducing a metal salt in an aqueous medium to form the metal particle; and
a second step of bringing the formed metal particle and the polypeptide into contact with each other.

14. A method of producing the conductive composition of claim 1, the method comprising:
a first step of heating a metal salt and the polypeptide to 40° C. or more to 150° C. or less in an aqueous medium to form a precursor in which a metal atom in the metal salt and a nitrogen atom in the polypeptide are chemically bonded to each other; and
a second step of reducing the precursor.

15. The method of producing the conductive composition according to claim 13, wherein the metal salt to be used is a recovered metal salt recovered from a metal waste liquid.

16. A method of recording a conductive image comprising a step of applying the conductive composition of claim 1 to a base material.

17. The method of recording a conductive image according to claim 16, wherein the step of applying the conductive composition to the base material is performed by an ink jet method.

18. The method of recording a conductive image according to claim 16, further comprising a step of drying the conductive composition applied to the base material at a temperature of 20° C. or more to 50° C. or less.

19. A conductive image comprising:
a base material; and
a conductive layer formed on the base material,
wherein the conductive layer comprises a metal particle and a polypeptide,
wherein the polypeptide comprises at least one kind of amino acid unit selected from the group consisting of: an acidic amino acid; and a neutral amino acid, and a ratio (% by mass) of the amino acid unit constituting the polypeptide is 95% by mass or more, and
wherein at least a part of a surface of the metal particle is coated with the polypeptide.

20. A conductive image to be recorded on a base material, wherein the conductive image is formed of the conductive composition of claim 1.

21. The conductive image according to claim 19, wherein the base material is glass, paper or a resin material.

22. The conductive image according to claim 21, wherein the resin material is a biocompatible material.

23. The conductive image according to claim 22, wherein the biocompatible material is at least one kind selected from the group consisting of: gelatin; collagen; fibroin; cellulose; and chitosan.

24. The conductive image according to claim 21, wherein the resin material is a synthetic resin.

25. The conductive image according to claim 24, wherein the synthetic resin comprises at least one kind of resin selected from the group consisting of: polyester; polyurethane; polyolefin; polystyrene; acrylic; polyvinyl chloride; polyvinyl acetate; polyamide; polyimide; polycarbonate; epoxy; and an acrylonitrile-butadiene-styrene copolymer.

26. The conductive image according to claim 24, wherein the synthetic resin comprises at least one kind of resin selected from the group consisting of: polyester; polyolefin; polyimide; and polycarbonate.
